(19) United States
(12) Patent Application Publication
(10) Pub. No.: US 2018/0101276 A1
(43) Pub. Date: Apr. 12, 2018

(54) DISPLAY DEVICE AND CORRECTION METHOD OF TOUCH OPERATION

(71) Applicant: Japan Display Inc., Tokyo (JP)

(72) Inventor: Jun HANARI, Tokyo (JP)

(21) Appl. No.: 15/691,890

(22) Filed: Aug. 31, 2017

(30) Foreign Application Priority Data
Oct. 6, 2016 (JP) 2016-198138

(51) Int. Cl. G06F 3/041

(52) U.S. Cl. CPC G06F 3/0418; G06F 3/044; G06F 2203/04102

(57) ABSTRACT

Provided is a display device possessing: a display panel; a touch sensor overlapping with the display panel; and at least one first sensor and at least one second sensor attached to the display panel. The first sensor is a flexible resistor which increases in resistance with increasing curvature. The second sensor is an acceleration sensor. The first sensor is arranged over the display panel or under the display panel.

### CROSS REFERENCE TO RELATED APPLICATIONS

This application is based on and claims the benefit of priority from the prior Japanese Patent Application No. 2016-198138, filed on Oct. 6, 2016, the entire contents of which are incorporated herein by reference.

### FIELD

An embodiment of the present invention relates to a display device on which a touch sensor is mounted.

### BACKGROUND

A touch sensor has been known as an interface for a user to input information to a display device. Arrangement of a touch sensor so as to overlap with a screen of a display device allows a user to operate input buttons, icons, and the like displayed on a screen, by which information can be readily input to a display device. A projection-capacitive touch sensor has been known as a typical example of a touch sensor. In a touch sensor of this mode, a plurality of transmitting electrodes (Tx) and a plurality of receiving electrodes (Rx) formed in a stripe shape are arranged so as to intersect each other, and capacitance is formed between the Tx and Rx. When a person's finger or the like directly or indirectly touches (hereinafter, this operation is referred to as a touch or a touch operation) a touch sensor, the capacitance is changed. Measurement of this change allows determination of a position of a touch (hereinafter, referred to as a touch position), that is, a x coordinate and a y coordinate on the touch sensor.

When a screen of a display device is formed so as to have a curved surface and a touch sensor is mounted thereover, an area where a finger of a user or the like makes contact with a touch sensor (hereinafter, referred to as a touch area) may be different depending on a touch position. Furthermore, a position on which a user attempts to touch may be different from a position on which the touch is actually performed, depending on a position in a screen. In order to correct such a difference in touch area, a shift of a touch position, and the like, an interval of Tx electrodes and/or Rx electrodes is/are continuously varied in Japanese Laid-Open Patent Publication No. 2013-25626.

### SUMMARY

An embodiment of the present invention is a display device possessing: a display panel; a touch sensor overlapping with the display panel; a housing including the display panel and the touch sensor; at least one first sensor disposed so as to change in shape according to a change in shape of the display panel; and at least one second sensor in the housing. The first sensor is a flexible resistor which increases in resistance with increasing curvature, and the second sensor is an acceleration sensor.

An embodiment of the present invention is a correction method of a touch operation of a display device. The display panel possesses: a display panel; a touch sensor overlapping with the display panel; a housing including the display panel and the touch sensor; at least one first sensor which is a flexible resistor increasing in resistance with increasing curvature; and at least one second sensor which is located in the housing and is an acceleration sensor. The correction method includes: determining a configuration of the display device by using the first sensor and the second sensor; determining a x coordinate and a y coordinate of a touch to the display panel by using the touch sensor; and correcting the x coordinate and a y coordinate according to the configuration. The configuration includes a shape and a position of the display device.

### BRIEF DESCRIPTION OF DRAWINGS

FIG. 1 is a perspective view of a display device according to an embodiment of the present invention;

FIG. 2A and FIG. 2B are respectively a top view and a bottom view of a display device according to an embodiment of the present invention;

FIG. 3A and FIG. 3B are diagrams explaining a configuration of a display device according to an embodiment of the present invention;

FIG. 4A and FIG. 4B are diagrams explaining a configuration of a display device according to an embodiment of the present invention;

FIG. 5A and FIG. 5B are diagrams explaining a configuration of a display device according to an embodiment of the present invention;

FIG. 6A to FIG. 6D are diagrams explaining a usage mode or a position of a display device according to an embodiment of the present invention;

FIG. 7A to FIG. 7C are diagrams explaining a usage mode of a display device according to an embodiment of the present invention;

FIG. 8 is a correction system of a display device according to an embodiment of the present invention;

FIG. 9 is a top view of a touch sensor of a display device according to an embodiment of the present invention;

FIG. 10 is a cross-sectional view of a display device according to an embodiment of the present invention;

FIG. 11A and FIG. 11B are cross-sectional views of a light-emitting element of a display device according to an embodiment of the present invention;

FIG. 12 is a cross-sectional view of a display device according to an embodiment of the present invention; and

FIG. 13 is a perspective view of a display device according to an embodiment of the present invention.

### DESCRIPTION OF EMBODIMENTS

Hereinafter, the embodiments of the present invention are explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate.

In the present invention, when a plurality of films is formed by performing etching or light irradiation on one film, the plurality of films may have functions or rules different from each other. However, the plurality of films originates from a film formed as the same layer in the same process and has the same layer structure and the same material. Therefore, the plurality of films is defined as films existing in the same layer.

In the specification and the scope of the claims, unless specifically stated, when a state is expressed where a structure is arranged “over” another structure, such an expression includes both a case where the substrate is arranged immediately above the “other structure” to be in contact with the “other structure” and a case where the structure is arranged over the “other structure” with an additional structure therebetween.

### First Embodiment

### 1. Outline Structure

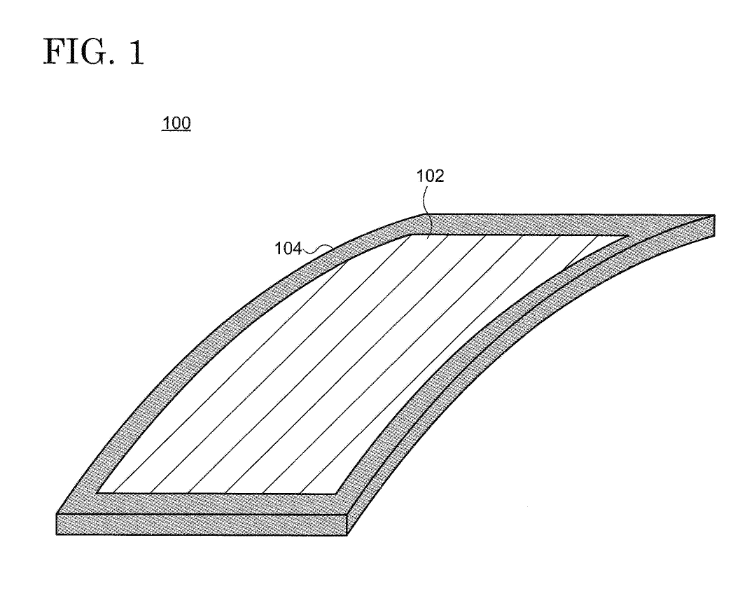

FIG. 1 is a schematic perspective view of a display device 100 according to the First Embodiment of the present invention on which a touch sensor is mounted (hereinafter, simply referred to as a display device). The display device 100 possesses a display panel 102 for displaying an image and a touch sensor 200 (described below) located over the display panel 102 and recognizing a touch. The display panel 102 and the touch sensor 200 may have flexibility and may be included in a housing 104.

The housing 104 may have flexibility or may have rigidity so that a shape thereof cannot be freely changed. When the housing 104 has flexibility, a user may arbitrarily change a shape of the display device 100 so that the display device 100 can be freely arranged on a curved wall or a columnar pillar, and a user can wear the display device 100 on a part of a body. On the other hand, when the housing 104 has rigidity, the display panel 102 and the touch sensor 200 may be installed in the housing 104 while maintaining a flat state or may be installed in the housing 104 after shaping to an arbitral shape. In this case, the shapes of the display panel 102 and the touch sensor 200 in a flat or bent state are maintained by the housing 104. The shape of the housing 104 may be determined in view of a shape of a location where the display panel 100 is arranged.

Although not illustrated, the housing 104 may be equipped with accessories such as a battery and a circuit board for driving the display device 100 as well as a camera and an audio-outputting portion.

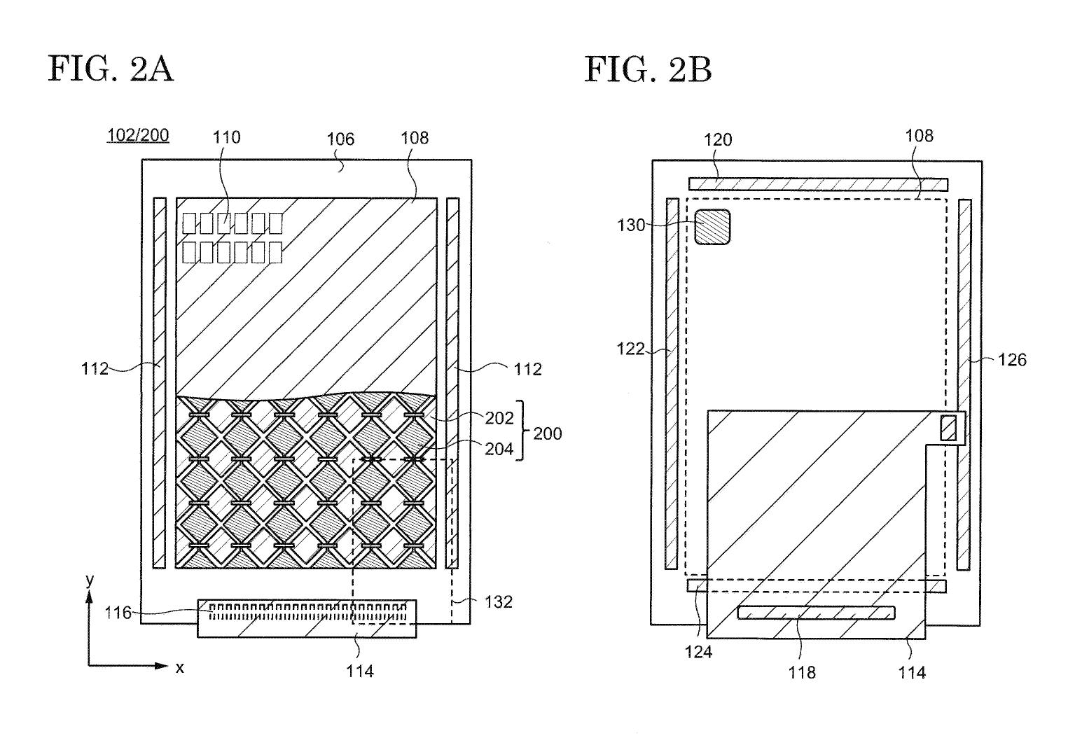

A top view and a bottom view of the display panel 102 over which the touch sensor 200 is mounted are shown in FIG. 2A and FIG. 2B, respectively. As shown in FIG. 2A, the display panel 102 has a display region 108 over a substrate 106, and the touch sensor 200 is arranged so as to overlap with the display region 108. The display panel 102 and the display region 108 may have a square shape with four sides as a whole. A plurality of pixels 110 is disposed in the display region 108. The pixels 110 are arranged in a matrix form and each provided with a display element such as a liquid crystal element and a light-emitting element. An image is reproduced on the display region 108 by these pixels 110.

Scanning-line side driver circuits 112 for controlling operation of the pixels 110 arranged in the display region 108 are formed over the substrate 106. It is not necessary to directly form the scanning-line side driver circuits 112 over the substrate 106, and a driver circuit formed over a substrate (e.g., a semiconductor substrate) different from the substrate 106 may be disposed over the substrate 106 or a connector 114 to control each pixel 110. Wirings which are not illustrated extend from the display region 108 to an edge portion of the substrate 106, and terminals 116 are provided at end portions of the wirings. The terminals 116 are connected to the connector 114, and a variety of signals for driving the display region 108 is supplied from an external circuit via the terminals 116. A flexible printed circuit (FPC) substrate and the like are represented as the connector 114.

The touch sensor 200 has a plurality of first touch electrodes 202 arranged in a stripe form in a row direction and a plurality of second touch electrodes 204 arranged in a stripe form in a column direction and intersecting the first electrodes 202. One of the first touch electrodes 202 and the second touch electrodes 204 is also called a transmitting electrode (Tx), and the other may be called a receiving electrode (Rx). The first electrodes 202 and the second electrodes 202 are spaced from each other, and capacitance is formed therebetween. A direct or indirect touch of a person's finger and the like to the display region 108 via the first touch electrodes 202 and the second touch electrodes 204 causes a change of the capacitance, and a touch position (x coordinate and y coordinate on the display region 108) can be determined by reading this change. Thus, the first electrodes 202 and the second electrodes 204 form the so-called projection-capacitive touch panel 200 in the display device 100. The first touch electrodes 202 and the second touch electrodes 204 are electrically connected to the connector 114 and a driver IC 118 via wirings which are not illustrated and the terminals 116, and a variety of signals for the touch sensor 200 is supplied from the external circuit therethrough.

Referring to the bottom view of FIG. 2B, first sensors 120, 122, 124, and 126 are provided under the substrate 106. The first sensors 120, 122, 124, and 126 are each a so-called curvature sensor which changes in electrical resistance (resistivity) when being bent to cause a change in curvature. Specifically, the first sensors 120, 122, 124, and 126 are configured to increase in resistivity when being largely bent, that is, with increasing curvature. For example, the first sensors 120, 122, 124, and 126 may be configured so that a cross-sectional area of a conductor arranged therein is changed by bending and the resistance is changed in accordance with the change of the cross-sectional area. As described below, when the substrate 106 has flexibility and can be bent, the shape of the display panel 102 can be recognized and determined by the first sensors 120, 122, 124, and 126.

An example is shown in FIG. 2B where the first sensors 120, 122, 124, and 126 are arranged under the substrate 106 (i.e., on an opposite side of the substrate 106 with respect to the display region 108). However, a part of or all of these sensors may be provided over the substrate 106. In this case, a part of the first sensors 120, 122, 124, and 126 may be located over and overlap with the scanning-line side driver circuits 112. Four first sensors 120, 122, 124, and 126 are provided so as to surround the display region 108 in FIG. 2B. However, it is not always necessary to provide four first sensors to the display panel 102, and three or less or five or more of the first sensors may be provided.

A second sensor 130 is further arranged under the substrate 106. The second sensor 130 is a so-called acceleration sensor, and a variety of acceleration sensors such as an electrostatic-capacitive type acceleration sensor, a piezo-resistance type acceleration sensor, and a gas-temperature distribution type acceleration sensor can be employed as the second sensor 130. As described below, the use of the second sensor 130 enables recognition of a position of the display device 100. Similar to the first sensors 120, 122, 124, and 126, the second sensor 130 may be arranged over the substrate 106. In this case, the second sensor 130 may overlap with the scanning-line side driver circuit 112. More than one second sensor 130 may be disposed. In this case, the second sensors 130 may be arranged on both top and bottom surfaces of the substrate 106.

It is not necessary for the first sensors 120, 122, 124, and 126 and the second sensor 130 to be in contact with the display panel 102 as long as the first sensors 120, 122, 124, and 126 are provided to the display 100 so that the shape thereof changes in accordance with the shape change of the display panel 102 and the second sensor 130 is installed in the housing 104.

### 2. Configuration of Display Device

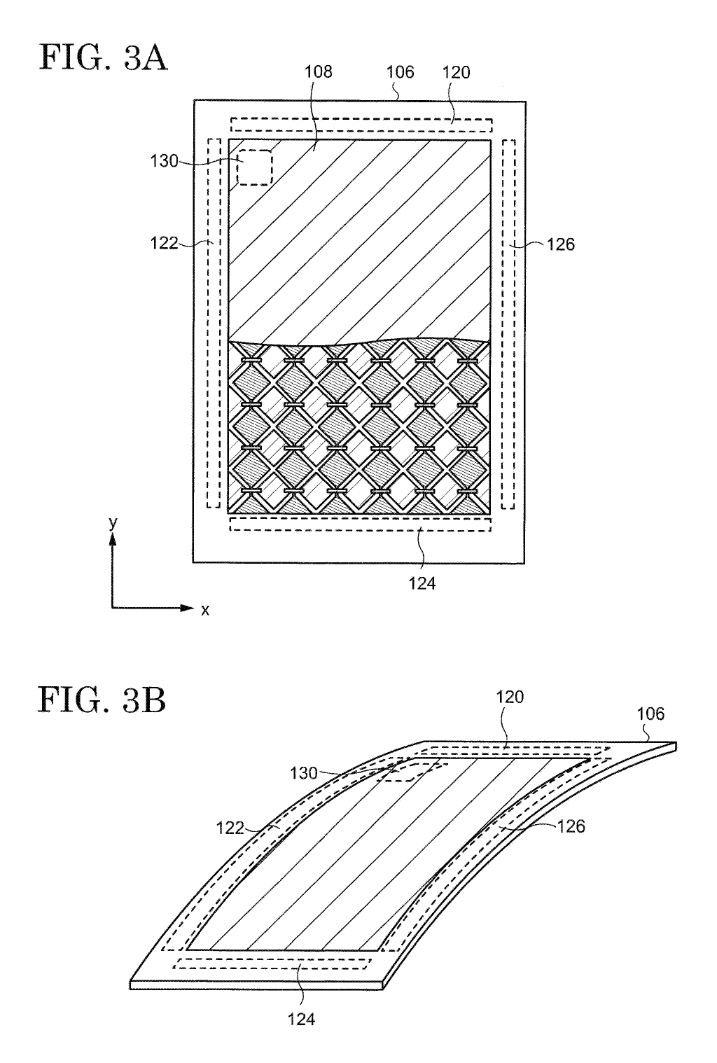

As described above, the display panel 102, the touch sensor 200, and the housing 104 structuring the display device 100 may have flexibility. Therefore, a user can utilize the display device 100 in a variety of configurations by transforming the display device 100 into an arbitral shape. The configuration of the display device 100 can be determined on the basis of outputs (or information) from the first sensors 120, 122, 124, and 126 and the second sensor 130. Here, the configuration includes a shape and a position of the display device 100. The shape is defined by the four sides of the display region 108. The position is determined by a vector of a normal line of the display panel 102 passing through a standard point where a point in the display region 108 is fixed as the standard point. Hereinafter, specific examples of the configuration are shown by using FIG. 3A to FIG. 5B. Note that in a part of these drawings, the touch sensor 200, the connector 114, the housing 104, and the like are omitted.

### Shape

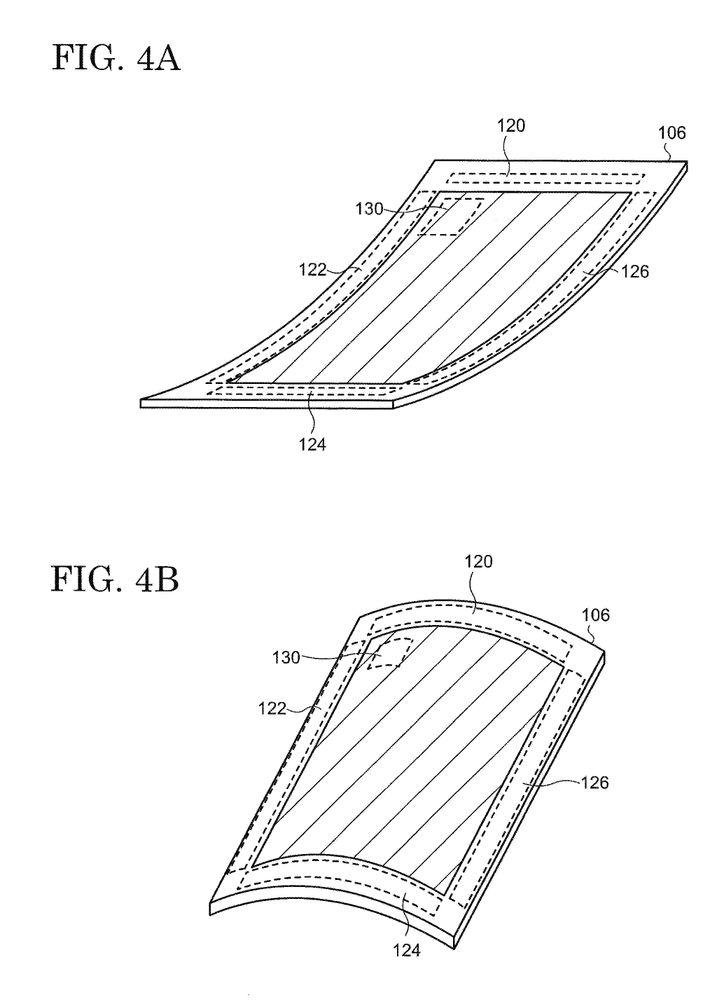

FIG. 3A corresponds to a case of using the display device 100 in a state where the display device 100 is not folded or bent and the almost entire display panel 102 is in a flat state. Here, a side of the substrate 106 on which the display region 108 is formed is defined as an upward direction, and an opposite thereof is defined as a downward direction. The shape shown in FIG. 3B is obtained by bending the y direction of the display panel 102 so that the display region 108 forms a projected portion protruding upward. On the other hand, the shape shown in FIG. 4A is obtained by bending the y direction of the display panel 102 so that the display region 108 forms a depressed portion sinking downward.

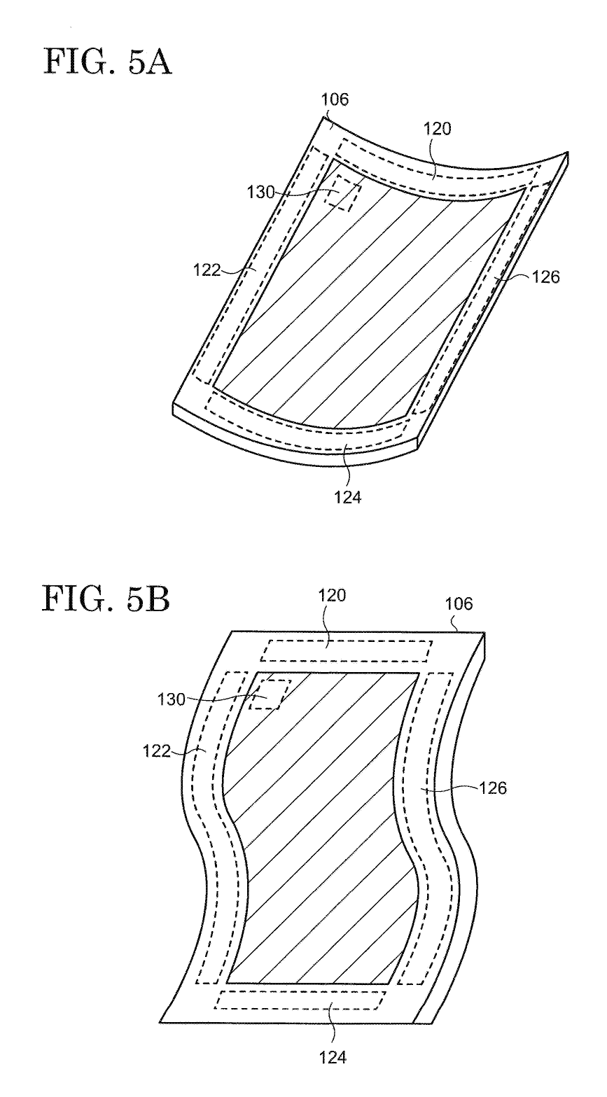

The shape shown in FIG. 4B is obtained by bending the x direction of the display panel 102 so that the display region 108 forms a projected portion protruding upward. On the other hand, the shape shown in FIG. 5A is obtained by bending the y direction of the display panel 102 so that the display region 108 forms a depressed portion sinking downward. Moreover, as shown in FIG. 5B, the display panel 102 is capable of having a wave shape by bending the y direction twice in different directions. In this case, a projected portion and a depressed portion are formed on the display panel 102. Although not shown, the display panel 102 may have a shape in which both x and y directions are simultaneously bent.

Such a variety of shapes can be recognized and determined by the first sensors 120, 122, 124, and 126 arranged so as to change in shape in accordance with the shape of the display panel 102.

### Position

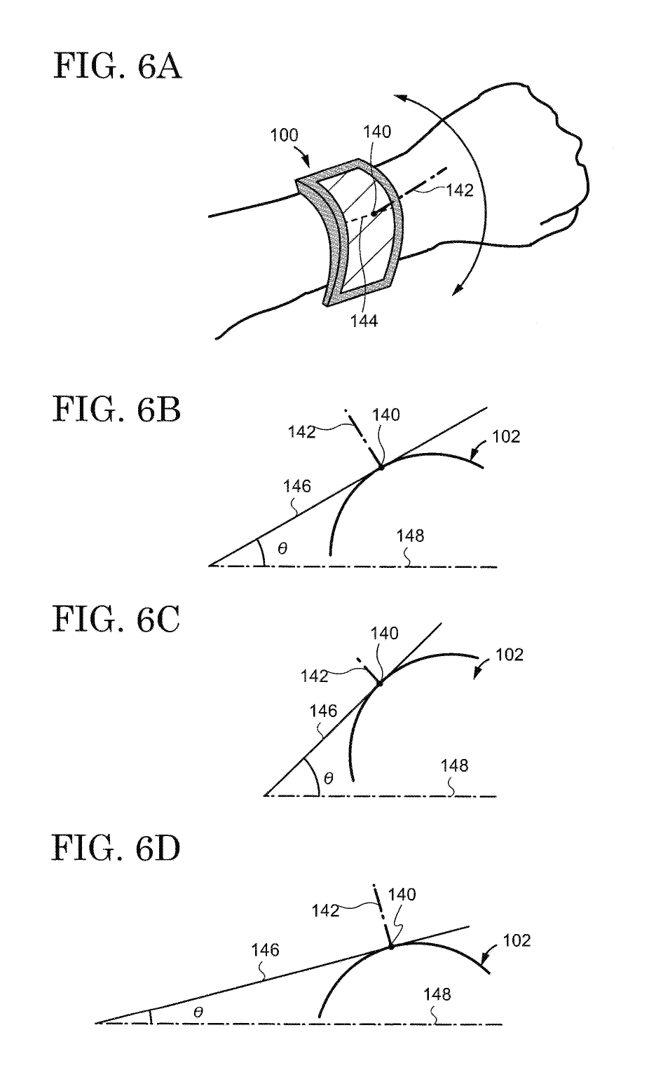

As described above, in the specification and the claims, the position of the display device 100 is determined by the vector of the normal line of the display panel 102 passing through the standard point 140 where a point in the display region 108 is set as the standard point 140 or by an angle between the vector of the normal line and the horizon. For example, a user's arm or the like is equipped with the display device 100, the display device 100 may rotate about the arm as an axis and take different positions with respect to the user and the horizon as indicated by an arrow in FIG. 6A. That is, the vector of the normal line 142 changes. Schematic cross-sectional views of these configurations are shown in FIG. 6A to FIG. 6D.

Here, as an example, the standard point 140 is set at a position closest to a user's eye, and a straight line which passes through the standard point 140 and which is parallel to a side selected from the sides of the display region 108 is defined as a standard line (or a front position) 144. The standard point 140 may be located on the surface of the touch sensor 200. This straight line becomes parallel to the selected side when the display panel 102 is transformed to a flat state. The selected side may maintain a straight-line shape during transformation of the display panel 102 from the flat state. As shown in FIG. 6B, it is possible to utilize, as one of indexes expressing the configuration of the display device 100, an angle θ of a tangent 146 which is in contact with the standard point 140 and perpendicularly intersects the standard line 144 with respect to the horizon 148. When the state in FIG. 6B is considered as a standard, FIG. 6C corresponds to a state where the display panel 102 faces downwards as a whole, and the angle θ at this state is larger than that of the state of FIG. 6B. On the other hand, in the state of FIG. 6D, the front face of the display panel 102 faces upward, and the angle θ is smaller than that of the state of FIG. 6B.

Estimation of this angle θ on the basis of the outputs or information from the second sensor 130 enables determination of the position of the display device 100. The configuration of the display device 100 is determined by two kinds of information including the aforementioned shape and position.

### 3. Outline of Correction

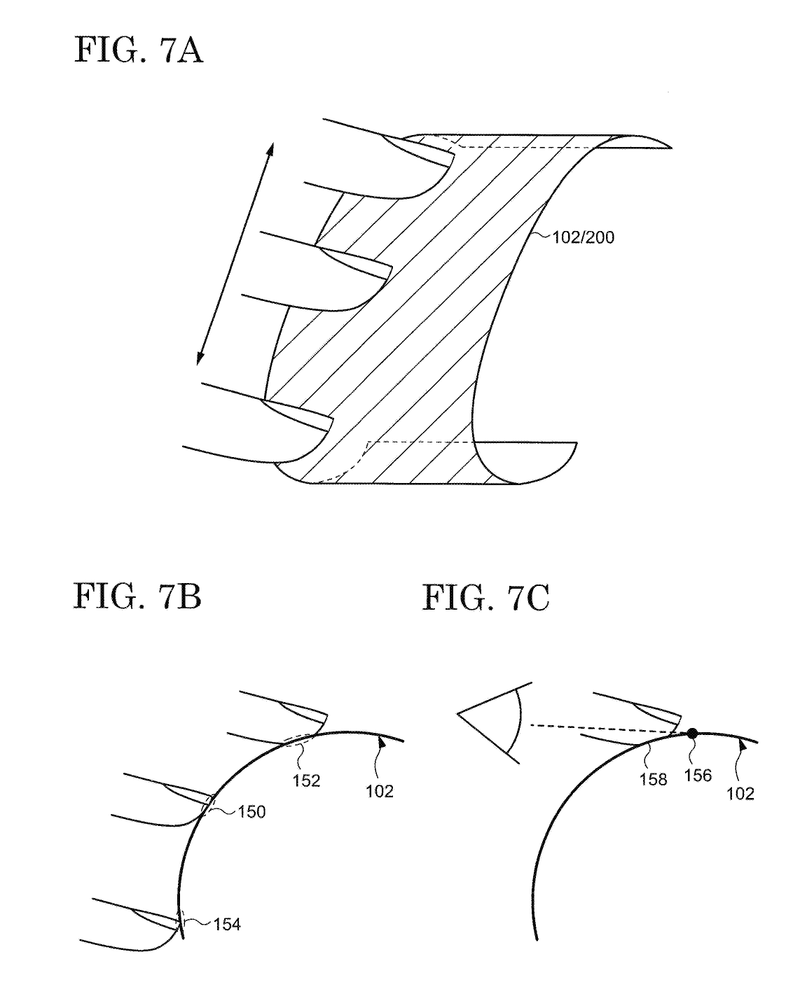

Hereinafter, an outline of correction when a user touches the display device 100 is explained. As shown in FIG. 7A, when a user directly or indirectly touches the touch sensor 200 over the bent display panel 102 with a finger, a touch area is different depending on the touched position. More specifically, as shown in FIG. 7B which is a schematic cross-sectional view of FIG. 7A, when a center (e.g., the standard line 144 defined as described above) of the display panel 102 or a vicinity of thereof is touched, a touch area 150 which is an area where the finger contacts with the display panel 102 is larger than a touch area 152 in the case where an upper portion of the display panel 102 is touched. This is because, when the upper portion is touched, a finger cushion more readily contacts with the display panel 102 than a fingertip and because a finger cushion is generally softer than a fingertip and readily deforms in accordance with the shape of the display panel 102. In contrast, a touch area 154 in the case where a lower position of the display panel 102 is touched is smaller than the touch area 150. One of the reasons is a smaller area of a fingertip than that of a finger cushion.

Therefore, even if a user attempts to touch the display panel 102 with uniform force, the display device 100 recognizes that a touch operation is performed at a location which is not intended to be touched by a user because the touch area is different depending on a location to which a user attempts to touch. Alternatively, the display device 100 misrecognizes that a touch operation is not performed at a location which is recognized to be touched by a user. Moreover, when the touch area fluctuates against a user's intention, a sensing level fluctuates and a usage feeling deteriorates because the change of the capacitance in the touch sensor 200 also fluctuates regardless of the user's intention.

Additionally, as shown in FIG. 7C, when a user attempts to touch a display 156 reproduced on an upper portion of the display panel 102, for example, a user may misrecognize that the display 156 is not reproduced at a position corresponding to the pixels 110 where the display 156 is reproduced but is reproduced at a position 158 which is lower than this position. As a result, the position of the display 156 cannot be correctly touched, causing a shift of the touch position.

In order to prevent such a change in touch area and a shift of the touch position, correction is performed. The correction can be conducted by using an appropriate correction coefficient for every line and column parallel to the standard line 144, for example. Specifically, the correction is performed with a system or a circuit described below.

### 3. System Structure and Correction Method

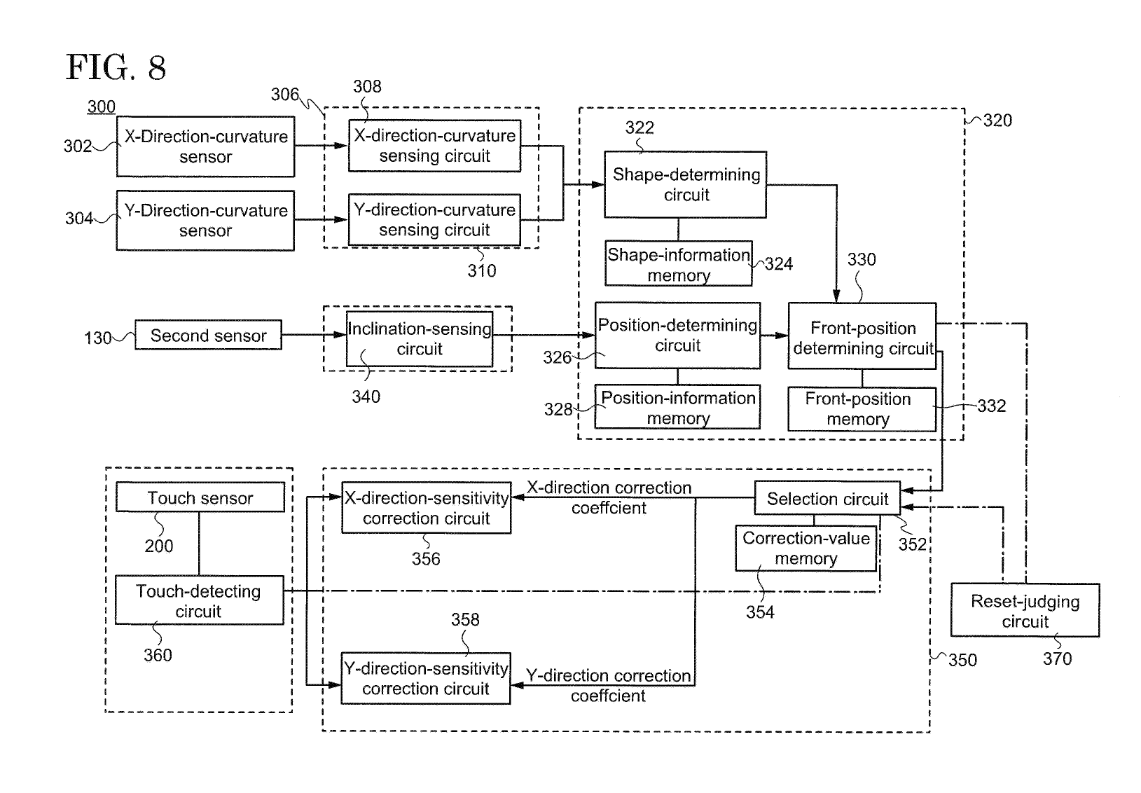

FIG. 8 shows a structure of a correction system 300 for sensing the touch to the display device 100 and correcting the touch position and the touch area.

### Determination of Configuration

A x-direction curvature sensor 302 and a y-direction curvature sensor 304 include the aforementioned first sensors. When a direction parallel to one side of the display region 108 is the x direction, and a direction perpendicular to the x direction is the y direction (see FIG. 2A), the former includes the first sensors 120 and 124, and the latter includes the first sensor 122 and 126. These sensors are deformed in accordance with the deformation of the display panel 102 and vary in resistivity on the basis of the amount of the transformation (curvature). The change in resistivity is read by a x-direction-curvature sensing circuit 308 and a y-direction-curvature sensing circuit 310 disposed in a curvature-sensing circuit 306. When two first sensors (e.g., first sensors 120 and 124) are arranged parallel to the x direction, the resistivity of each first sensor may be read by the x-direction-curvature sensing circuit 308.

Signals output from the curvature-sensing circuit 306 are input to a shape-determining circuit 322 provided in a configuration-determining circuit 320. In a shape-information memory 324, a data table which summarizes a relationship between the resistivities in the x direction and the y direction respectively read by the x-direction-curvature sensing circuit 308 and the y-direction-curvature sensing circuit 310 and the curvatures in the x direction and the y direction is stored. Alternatively, a calibration equation between the resistivity and the curvature may be stored in the shape-information memory 324. Furthermore, the resistivities in the x direction and y direction which are provided by a presupposed shape or a previously experienced shape of the display panel 102 may be stored. The shape-determining circuit 322 is configured, on the basis of the resistivities in the x direction and the y direction read by the x-direction-curvature sensing circuit 308 and the y-direction-curvature sensing circuit 310, to determine the shape of the display panel 102 or read out, from the shape-information memory 324, a shape having resistivities closest to the resistivities read by the x-direction-curvature sensing circuit 308 and the y-direction-curvature sensing circuit 310, while referring to the resistivities in the x direction and the y direction stored in the shape-information memory 324. With these procedures, the shape of the display panel 102 is determined.

The signals output by the second sensor 130 are input to an inclination-sensing circuit 340, processed therein, and then input, as position information, to a position-determining circuit 326 provided in the configuration-determining circuit 320. It is possible to store a data table or a calibration equation summarizing a relationship between the signals output from the inclination-sensing circuit 340 (e.g., acceleration signals of three axes in x, y, and z directions) and the positions (e.g., the aforementioned angle θ) in a position-information memory. Alternatively, a presupposed position, a previously experienced position, and signals corresponding thereto may be stored. The position-determining circuit 326 is configured, on the basis of the signals output from the inclination-sensing circuit 340, to determine the position of the display panel 102 or read out a position providing a signal closest to the signal while referring to the information stored in the position-information memory 328.

The information regarding the conformation of the display panel 102 determined by the shape-determining circuit 322 and the position-determining circuit 326 is input to a front-position determining circuit 330. It is possible to store in a front-position memory 332 a data table summarizing a relationship of the presupposed configuration or a previously experienced configuration with the standard point 140 or the standard line 144 of the display panel 102. The front-position determining circuit 330 refers to the information stored in the front-position memory 332 and determines the standard line 144 (front position) of the display panel 102 on the basis of the information with respect to the configuration of the display panel 102.

### Correction

The information regarding the front position and the configuration of the display panel 102 is output to a selection circuit 352 provided in a correction-value selecting circuit 350 through the front-position determining circuit 330. It is possible to store in a correction-value memory 354, as correction coefficients, a x-direction correction coefficient and a y-direction correction coefficient which utilize the front position as a standard on the basis of the configuration of the display panel 102 and the front position. The selection circuit 352 reads out the x-direction correction coefficient and the y-direction correction coefficient on the basis of the configuration of the display panel 102 and the front position, and outputs them to a x-direction-sensitivity correction circuit 356 and a y-direction-sensitivity correction circuit 358, respectively.

In the touch sensor 200, capacitance changes upon a touch by a user, and this change is read by a touch-detecting circuit 360 so that a x coordinate and a y coordinate of the touch are estimated. The data of the estimated x coordinate and the y coordinate are output to the x-direction-sensitivity correction circuit 356 and the y-direction-sensitivity correction circuit, respectively.

In the x-direction-sensitivity correction circuit 356 and the y-direction-sensitivity correction circuit, the x coordinate and the y coordinate of the touch, which are input from the touch-detecting circuit 360, are corrected on the basis of the x-direction correction coefficient and the y-direction correction coefficient input from the selection circuit 352. For example, the correction may be performed so that the area which is intended to be touched by a user is increased or decreased from the touch area actually recognized by the touch sensor 200 the further separated from the standard line 144 the touch is. This correction may be carried out by varying the correction coefficients for every row or column of the matrix of the pixels 110 with the standard line 144 used as a standard. Alternatively, the correction may be conducted so that the touch position actually recognized by the touch sensor 200 is shifted in the x direction or the y direction the further separated from the standard line 144 the touch is.

Note that the shape-information memory 324, the position-information memory 328, the front-position memory 332, and the correction-value memory 354 are each illustrated as an independent memory in FIG. 8. However, these memories can be integrated as one memory, and this memory may be divided into several sectors used for the shape-information memory 324, the position-information memory 328, the front-position memory 332, and the correction-value memory 354.

### Setting

In the aforementioned method, the x-direction correction coefficient and the y-direction correction coefficient as correction values are determined by the configuration of the display panel 102 and the front position. However, these circuits may be configured so that the correction of the touch position and the touch area is actively set by a user independently from or in association with these kinds of information. For example, when a user sets the correction value, a plurality of icons or an appropriate trace pattern is displayed on the display region 108, and the user is requested to touch the icons or trace the pattern. At this time, information with respect to the touch position estimated by the touch sensor 200 and the touch-detecting circuit 360 and information with respect to the position of the actually displayed icons are input to the selection circuit 352. In the selection circuit 352, correction coefficients are newly generated on the basis of a shift of the touch in the aforementioned operation by the user and input to the x-direction-sensitivity correction circuit 356 and the y-direction-sensitivity correction circuit 358. With this procedure, the correction value can be set by a user. In this setting operation, a provisional correction value may be generated by the correction circuit 352, and the touch may be corrected on the basis of the provisional correction value.

Note that the correction system 300 may be configured so that the setting of the correction value by a user is performed when the display device 100 is started up.

Moreover, a reset-judging circuit 370 may be provided to the correction system 300 in order to automatically judge whether the correction value should be reset or not. A program for detecting fluctuation of touch sensitivity caused by the shift of the touch position and the change of the touch area may be installed to the reset-judging circuit 370. For example, the reset-judging circuit 370 may be configured so that, when a user touches icons or banners displayed on the display region 108, information with respect to the actually displayed positions of the icons or the banners and information with respect to the touch position and the touch area of a user are appropriately stored. When a gap therebetween is judged to be large, a user may be urged to reset the correction value. Note that, the reset-judging circuit 370 may be configured so as to have certain hysteresis in judging whether the reset is necessary because an extremely high frequency of the automatic reset decreases a usage feeling by a user.

Alternatively, the reset-judging circuit 370 may be configured so as to obtain the information regarding the configuration of the display panel 102 and the information regarding the front position from the shape-determining circuit 322, the front-position determining circuit 330, the position-determining circuit 326, and the like at a constant interval and input these kinds of information to the selection circuit 352. With this configuration, a new correction value is selected or generated in the selection circuit 352 on the basis of the information with respect to the configuration of the display panel 102 and the front position. Accordingly, the correction can be timely performed while following the change of the configuration of the display device 100.

As described above, in the display device 100 according to the present embodiment, the correction of the touch position and the touch area is carried out on the basis of the configuration of the display panel 102. Therefore, even if the shape and the position of the display device 100 is varied in accordance with the environment in usage, the touch can be correctly detected and a usage feeling of the touch sensor 200 is not deteriorated. Accordingly, a display device having a wide application field can be provided.

### Second Embodiment

In the present embodiment, a structure of the display device 100 described in the First Embodiment is described in detail.

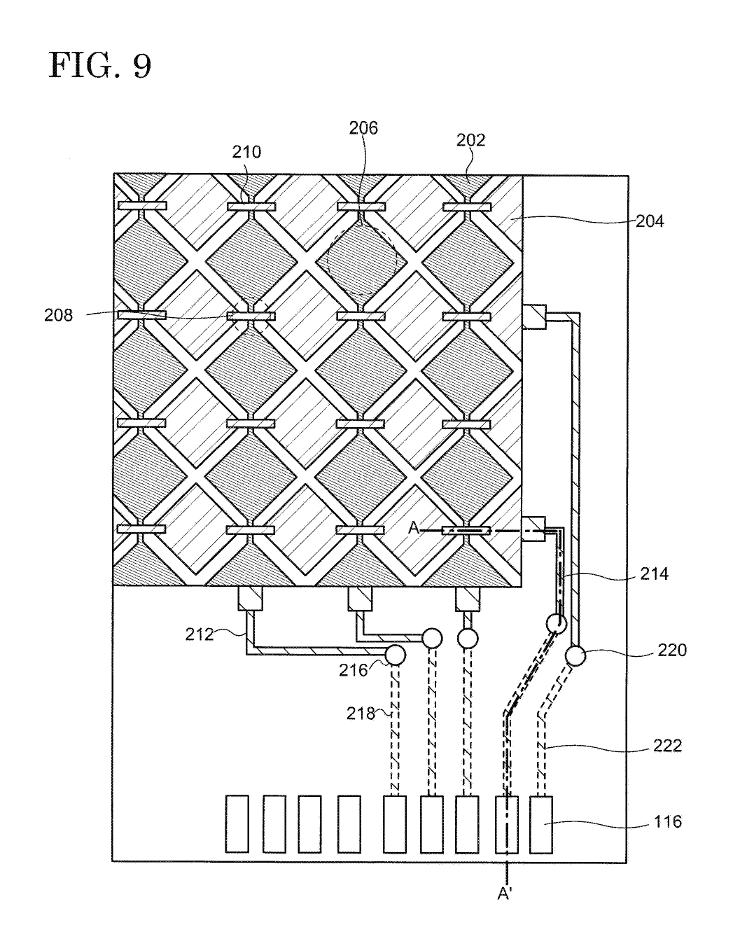

An enlarged diagram of a region 132 of FIG. 1 is schematically shown in FIG. 9. As described above, the touch sensor 200 has the plurality of first touch electrodes 202 and the plurality of second touch electrodes 204. The plurality of first touch electrodes 202 is arranged at substantially the same interval from one another. Similarly, the plurality of second touch electrodes 204 is arranged at substantially the same interval from one another.

The plurality of first touch electrodes 202 and the plurality of second touch electrodes 204 each have a plurality of square regions having a substantially square shape (diamond electrode) 206 and connection regions 208 each located between adjacent diamond electrodes 206. The diamond electrodes 206 and the connection regions 208 alternate with each other. The first touch electrodes 202 and the second touch electrodes 204 are spaced from and electrically independent from one another. The diamond electrodes 206 of the first touch electrodes 202 and the second touch electrodes 204 may be formed in the same layer or different layers. An example is shown in FIG. 9 where these electrodes are formed in the same layer. In this case, the adjacent diamond electrodes 206 are electrically connected with each other by a bridge wiring 210 in one of the first touch electrode 202 and the second touch electrode 204.

The first touch electrodes 202 are electrically connected to first wirings 212 extending from outside the display region 108. The first wirings 212 extend outside the display region 108 and are electrically connected to first terminal wirings 218 in contact holes 216. The first terminal wirings 218 are exposed at a vicinity of the edge portion of the display panel 102 to form the terminals 116.

Similarly, the second touch electrodes 204 are electrically connected to second wirings 214 extending from outside the display region 108. The second wirings 214 extend outside the display region 108 and are electrically connected to second terminal wirings 222 in contact holes 220. The second terminal wirings 222 are exposed at the vicinity of the edge portion of the display panel 102 to form the terminals 116.

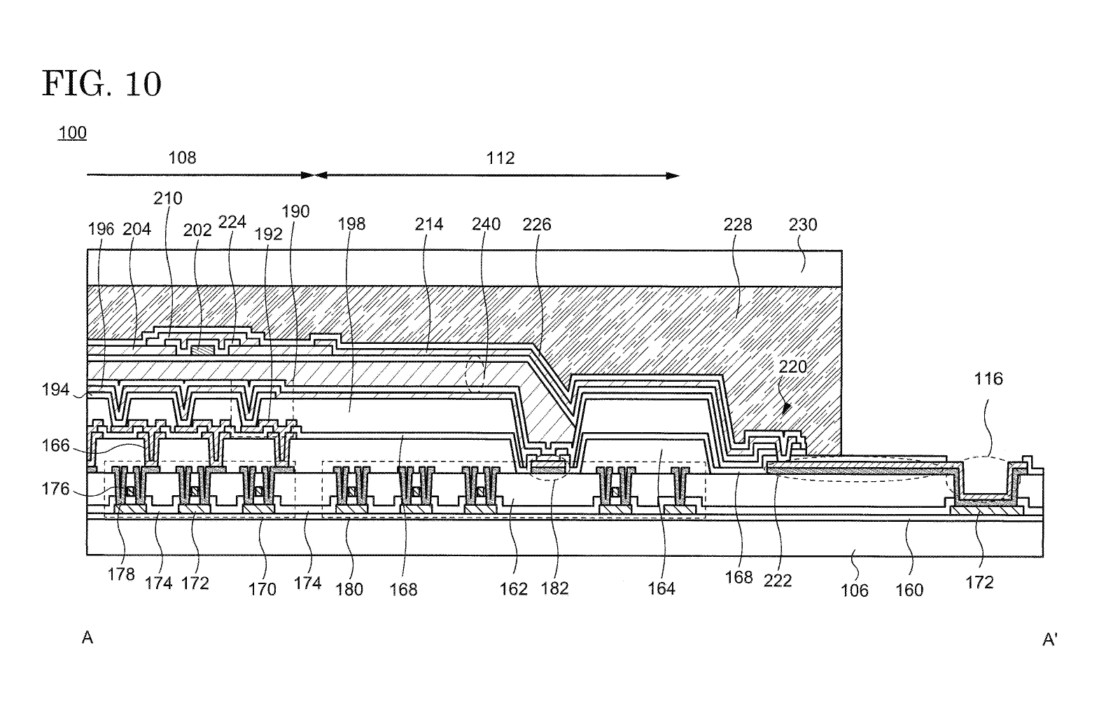

FIG. 10 shows a schematic cross-sectional view of the display device 100. FIG. 10 is a cross section along a chain line A-A′ of FIG. 9 and shows a cross section from the display region 108 to the terminal 116 through the second wiring 214 and the second terminal wiring 222.

The display device 100 has the substrate 106 over which, through a base film 160 as an optional structure, a transistor 170 for controlling the pixel 110 and a transistor 180 of the scanning-line side driver circuit 112 are provided. The substrate 106 may contain a polymer material such as a polyimide, a polyamide, a polycarbonate, and a polyester. In this case, the substrate 106 may be called a base film or a sheet base material because the substrate 106 is capable of having flexibility. When the display device 100 is not provided with flexibility, the substrate 106 may include glass, quartz, a metal, ceramics, or the like.

The base film 160 is a film to prevent diffusion of impurities such as an alkaline metal from the substrate 106 to the transistors 170 and 180 and the like, and may include an inorganic compound such as silicon nitride, silicon oxide, silicon nitride oxide, and silicon oxynitride. The base film 160 may be formed as a single-layer structure or a stacked-layer structure. The base film 106 can be formed by applying a chemical vapor deposition method (CVD method), a sputtering method, or the like.

The transistor 170 includes a semiconductor film 172, a gate insulating film 174, a gate electrode 176, source/drain electrodes 178, and the like. The gate electrode 176 overlaps with the semiconductor film 172 through the gate insulating film 174, and a region overlapping with the gate electrode 176 is a channel region of the semiconductor film. The semiconductor film 172 may have source/drain regions so as to sandwich the channel region. An interlayer film 162 may be formed over the gate electrode 176, and the source/drain electrodes 178 are electrically connected to the semiconductor film 172 in openings provided in the interlayer film 162 and the gate insulating film 174. Note that a part of the semiconductor film 172 may be formed in a region where the terminal 116 is formed.

The semiconductor film 172 may contain a Group 14 element such as silicon. Alternatively, the semiconductor film 172 may include an oxide semiconductor. As an oxide semiconductor, Group 13 elements such as indium and gallium are represented, and a mixed oxide of indium and gallium (IGO) is exemplified. When an oxide semiconductor is used, the semiconductor film 172 may further contain a Group 12 element, and a mixed oxide including indium, gallium, and zinc (IGZO) is represented as an example. Crystallinity of the semiconductor film 172 is not limited, and the semiconductor film 172 may be single crystalline, polycrystalline, microcrystalline, or amorphous.

When the semiconductor film 172 includes silicon, the semiconductor film 172 may be formed with a CVD method by using a silane gas and the like as a raw material. Crystallization may be conducted by performing a heat treatment or applying light such as a laser on the obtained amorphous silicon. When the semiconductor film 172 includes an oxide semiconductor, the semiconductor film 172 can be formed by utilizing a sputtering method.

The gate insulating film 174 may have a single-layer or stacked-layer structure and may be formed with a method similar to that for the base film 160.

The gate electrode 176 can be formed by using a sputtering method or a CVD method. The gate electrode 176 may be formed with a metal such as titanium, aluminum, copper, molybdenum, tungsten, and tantalum or an alloy thereof so as to have a single-layer or stacked-layer structure. For example, a structure may be employed in which a metal with a high conductivity, such as aluminum and copper, is sandwiched by a metal with a relatively high melting point, such as titanium, tungsten, and molybdenum.

The interlayer film 162 may have a single-layer or stacked-layer structure and can be formed with a method similar to that for the base film 160. In the case of a stacked structure, a film including an inorganic compound may be stacked after a layer including an organic compound is formed, for example.

The opening portions reaching the semiconductor film 172 of the transistor 170 and the semiconductor film 172 forming the terminals 116 are formed in the interlayer film 162 and the gate insulating film 174. The opening portions can be formed by performing plasma etching in a gas including a fluorine-containing hydrocarbon, for example. The source/drain electrodes 178 and a part of the second terminal wiring 222 are formed so as to cover the opening portions. That is, the second terminal wiring 222 has two layers, and the lower one is formed simultaneously with the source/drain electrodes 178.

Furthermore, when the source/drain electrodes 178 and the second terminal wiring 222 are formed, a part of a cathode contact 182 for supplying a potential to a second electrode 196 of the light-emitting element 190 is formed simultaneously. The cathode contact 182 also may have a two-layer structure, and the lower layer of the two-layer structure is formed when the source-drain electrodes 178 are formed. The source/drain electrodes 178, the lower layer of the second terminal wiring 222, and the lower layer of the cathode contact 182 may have the same structure and may be prepared with the same method as those of the gate electrode 176. For example, a stacked structure of titanium/aluminum/titanium, a stacked structure of molybdenum/aluminum-neodymium alloy/molybdenum, and the like may be employed.

A detailed explanation is omitted because the transistor 180 has the same structure as the transistor 170. In FIG. 10, the transistors 170 and 180 are illustrated as a top-gate type transistor. However, there is no limitation to the structures of the transistors 170 and 180, and the transistors 170 and 180 may be a bottom-gate type transistor, a multi-gate type transistor having a plurality of gate electrodes 176, or a dual-gate transistor having a structure in which the semiconductor film 172 is vertically sandwiched by two gate electrodes 176.

A leveling film 164 is provided over the transistors 170 and 180. The leveling film 164 has a function to absorb depressions and projections caused by the semiconductor elements such as the transistors 170 and 180 and give a flat surface. The leveling film 164 may be formed with an organic insulator. As an organic insulator, a polymer material such as an epoxy resin, an acrylic resin, a polyimide, a polyamide, a polyester, a polycarbonate, and a polysiloxane is represented, and the leveling film 164 can be formed with a wet-type film-formation method such as a spin-coating method, a printing method, and an ink-jet method.

The leveling film is provided with opening portions to expose the source/drain electrode 178 of the transistor 170, the cathode contact 182, the lower layer of the second terminal wiring 222, and the lower layer of the terminal 116. A connection electrode 166 is formed so as to cover the opening portions. As a result, the connection electrode 166 is electrically connected to the source/drain electrode 178 in the display region 108, and the upper layer of the cathode contact 182 and the upper layer of the terminal 116 are simultaneously formed. A conductive oxide capable of transmitting visible light, such as indium-tin oxide (ITO) and indium-zinc oxide (IZO) can be used for the connection electrode 166, and the connection electrode 166 can be formed with a sputtering method. The use of the connection electrode 166 enables protection of the source/drain electrode 178, the lower layer of the cathode contact 182, and the lower layer of the second terminal wiring 222 in the following processes, thereby realizing contacts with low contact resistance.

The display device 100 further possesses an insulating film 168 covering an edge portion of the contact electrode 166. The insulating film 168 may have the same structure and may be prepared with the same method as those of the base film 160 or the interlayer film 162.

The display device 100 further has, over the connection electrode 166 electrically connected to the source/drain electrode 178, the first electrode (pixel electrode) 192 covering an opening portion of the insulating film 168. When light emission from the light-emitting element 190 is extracted through the second electrode 196, the first electrode 192 is configured to reflect visible light. In this case, a metal with high reflectance, such as silver and aluminum, or an alloy thereof is used for the first electrode 192. Alternatively, a film of a conductive oxide having a light-transmitting property is formed over a film including the metal or the alloy. For example, a three-layer structure of conductive oxide/silver or aluminum/conductive oxide and a two-layer structure of silver or aluminum/conductive oxide are represented. When the light emission from the light-emitting element 190 is extracted through the first electrode 192, the first electrode 192 may be formed by using ITO or IZO. Since the touch sensor 200 is disposed over the display panel 102, the first electrode 192 is provided as an electrode reflecting visible light.

A partition wall 198 is provided to the display device so as to cover an edge portion of the first electrode 192. With the partition wall 198, a step caused by the first electrode 192 and the like is absorbed, and the first electrodes 192 of the adjacent pixels 110 can be electrically insulated from each other. The partition wall 198 may be formed with a wet-type film-formation method by using a material applicable in the leveling film 164, such as an epoxy resin, an acrylic resin, and a polyimide.

The light-emitting element 190 possesses a functional layer and the second electrode 196 provided so as to cover the first electrode 192 and the partition wall 198. The functional layer 194 mainly includes an organic compound and can be formed by applying a wet-type film-formation method or a dry-type film-formation method such as an evaporation method. A structure of the light-emitting element 190 is described below. The second electrode 196 is prepared so as to cover the upper layer of the cathode contact 182 and be electrically connected to the cathode contact 182, by which a potential can be supplied to the second electrode 196 through the cathode contact 182.

When the light emission from the light-emitting element 190 is extracted through the first electrode 192, a metal such as aluminum, magnesium, or silver or an alloy thereof may be used as the second electrode 196. On the other hand, when the light emission from the light-emitting element 190 is extracted from the second electrode 196, a conductive oxide with a light-transmitting property, such as ITO, may be used as the second electrode 196. Alternatively, the aforementioned metal may be disposed at a thickness which permits visible light to pass therethrough. In this case, a conductive oxide with a light-transmitting property may be further stacked.

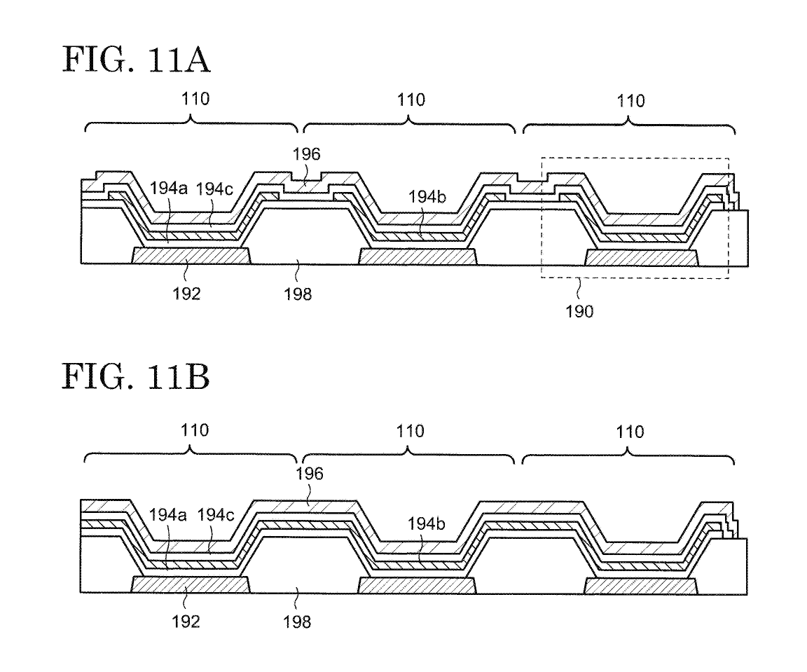

A structure of the light-emitting element 190 is shown in FIG. 11A and FIG. 11B. The light-emitting element 190 is structured by the first electrode 192, the second electrode 194, and the functional layer 194 sandwiched therebetween. Carriers (electrons and holes) injected from the first electrode 192 and the second electrode 194 are recombined in the functional layer 194, which results in formation of an excited state of a molecule in the functional layer 194. Energy released when the excited state relaxes to a ground state is radiated as light, by which light emission is recognized.

A structure of the functional layer 194 may be appropriately selected, and the functional layer 194 can be structured by combining a carrier-injection layer, a carrier-transporting layer, an emission layer, a carrier-blocking layer, an exciton-blocking layer, and the like, for example. An example is illustrated in FIG. 11A where the functional layer 194 possesses three layers 194a, 194b, and 194c. In this case, the layer 194a may be a carrier (hole) injection/transporting layer, the layer 194b may be an emission layer, and the layer 194c may be a carrier (electron) injection/transporting layer. Each of these layers 194a, 194b, and 194c may be composed of a plurality of layers.

The layer 194b serving as an emission layer may be configured to include different materials between the adjacent pixels 110 as shown in FIG. 11A. In this case, other layers 194a and 194c may be continuously formed over the pixels 110 and the partition wall 198 so as to be shared by the plurality of pixels 110. Emission colors different between the pixels 110 can be obtained by appropriately selecting materials used in the layer 194b. Alternatively, the structure of the layer 194b may be the same between the pixels 110 as shown in FIG. 11B. In this case, the layer 194b may be continuously formed over the pixels 110 and the partition wall 198 so as to be shared by the plurality of pixels 110. This structure allows the same emission color to be output from the layer 194b of the pixels 110. Thus, a variety of colors (e.g., red, green, and blue) may be extracted by configuring the layer 194b to be white-emissive and using a color filter.

The display device 100 may further have a sealing film 240 over the light-emitting element 190. A structure of the sealing film 240 may be arbitrarily selected, and a stacked structure of a first layer 242 including an inorganic compound, a second layer 244 including an organic compound, and a third layer 246 including an inorganic compound is represented as an example.

The first layer 242 can be formed so as to cover the light-emitting element 190, the cathode contact 182, and a part of the second terminal wiring 222. The first layer 242 may include an inorganic material such as silicon nitride, silicon oxide, silicon nitride oxide, and silicon oxynitride and may be formed with the same method as the base film 160.

The second layer 244 may include an organic resin including an acrylic resin, a polysiloxane, a polyimide, and a polyester. Moreover, as shown in FIG. 10, the second layer 244 may be formed so as to have a thickness which allows depressions and projections caused by the partition wall 198 to be absorbed and a flat surface to be provided. The second layer 244 is preferred to be selectively formed within the display region 108. That is, it is preferred that the second layer 244 be formed so as not to overlap with the second terminal wiring 222 and the terminal 116. The second layer 244 can be formed with a wet-type film-formation method such as an ink-jet method. Alternatively, the second layer 244 may be prepared by atomizing or gasifying oligomers serving as a raw material of the aforementioned polymer material under a reduced pressure, spraying the first layer 242 with the oligomers, and then polymerizing the oligomers.

The third layer 246 may have the same structure and may be formed with the same method as that of the first layer 242. The third layer 246 can be also formed so as to cover not only the second layer 244 but also the second terminal wiring 222, by which the second layer 244 having a higher hydrophilicity than the first layer 242 and the third layer 246 can be sealed with the first layer 242 and the third layer 246. Hence, entrance of impurities from outside and diffusion thereof in the display region 108 can be more effectively prevented.

The touch sensor 200 is arranged over the sealing film 240. In the example shown in FIG. 10, the touch sensor 200 possesses, over the third layer 246 of the sealing film 240, the first touch electrode 202 and the second touch electrode 204 which are provided in the same layer. An interlayer insulating film 224 is disposed between the adjacent diamond electrodes 206 of the second touch electrode 204 so as to cover the edge portions thereof over which the bridge wiring 210 electrically connecting the diamond electrodes 206 is formed. Note that, a contact hole 220 is formed so as to expose a part of the second terminal wiring 222 prior to the formation of the bridge wiring 210, and the second wiring 214 for electrically connecting the second touch electrode 204 and the second terminal wiring 222 is formed simultaneously with the formation of the bridge wiring 210.

The first touch electrode 202 and the second touch electrode 204 may include a conductive oxide transmitting visible light, such as ITO and IZO. The interlayer insulating film 224 may be formed with an inorganic insulator such as silicon oxide, silicon nitride, silicon nitride oxide, and silicon oxynitride or a polymer material such as an acrylic resin, an epoxy resin, and a polyimide. A metal such as molybdenum, tungsten, and titanium or an alloy thereof can be used for the bridge wiring 210 and the second wiring 214, for example.

When the first touch electrode 202 and the second touch electrode 204 are formed in different layers, the interlayer insulating film 204 may be formed between the first touch electrode 202 and the second touch electrode 204. In this case, it is not necessary to form the bridge wiring 210, and the second wiring 214 can be formed simultaneously with one of the first touch electrode 202 and the second touch electrode 204.

The display device 100 may further possess, as an optional structure, a first protection film 226 over the first touch electrode 202 and the second touch electrode 204. An inorganic insulator such as silicon nitride and silicon oxide may be used for the first protection film 226.

A second protection film 230 is fixed over the first protection film 226 with an adhesion layer 228. An epoxy-based adhesive can be typically used for the adhesion layer 228. A polymer material transmitting visible light may be used for the second protection film 230, and a film including a polyester, a polycarbonate, a polyolefin, or the like is represented, for example.

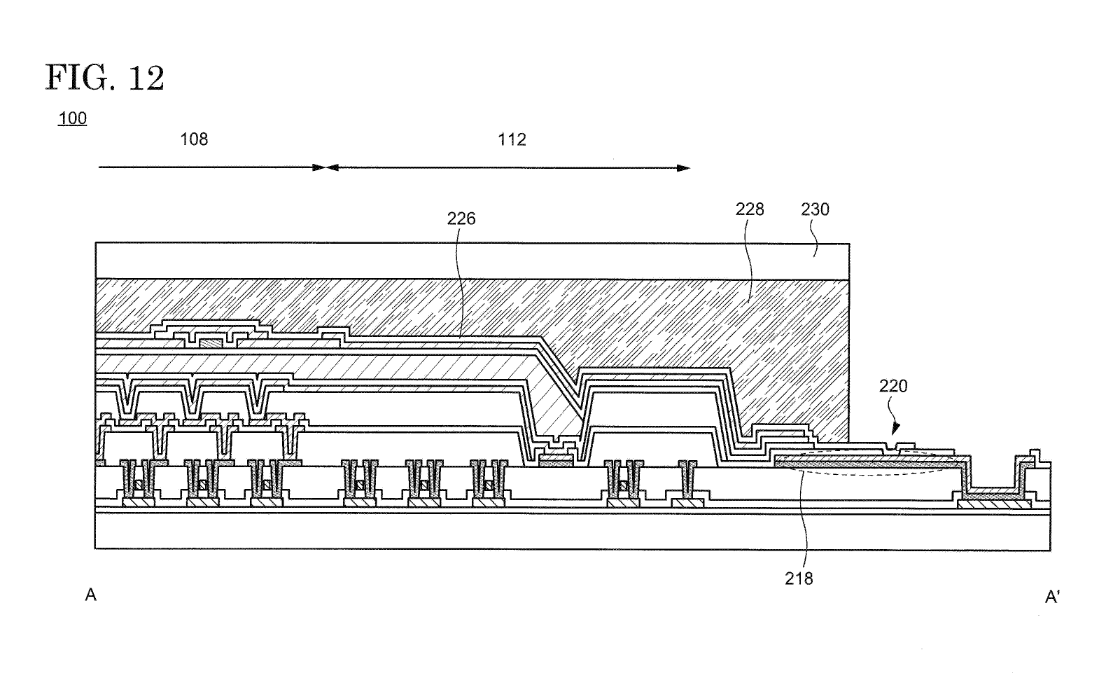

In the structure shown in FIG. 10, the contact hole 220 through which the second wiring 214 and the second terminal wiring 222 are connected is covered with the second protection film 230 and the adhesion layer 228. However, the structure of the display device 100 is not limited thereto, and the contact hole 220 may be formed in a region which is not covered by the second protection film 230 and the adhesion layer 228 (see FIG. 12).

### Third Embodiment

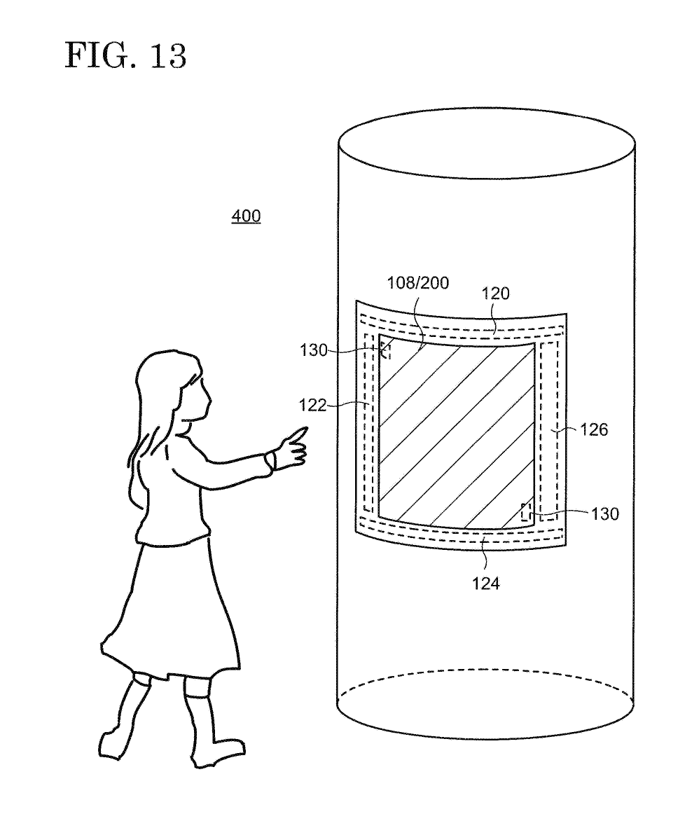

In the present embodiment, an application example of the display device 100 described in the First Embodiment is demonstrated. A display device 400 according to the present embodiment can be applied to an advertisement (signage), and a schematic diagram thereof is shown in FIG. 13. In FIG. 13, a state is illustrated where the display device 400 is attached to a bent wall or pillar, and the display region 108 forms a projected portion.

Similar to the display device 100, the first sensors 120, 122, 124, and 126 are arranged in the display device 400 so as to surround the display region 108 and the touch sensor 200, and the plurality of second sensors 130 is provided. The shape of the display device 400 can be determined by the first sensors 120, 122, 124, and 126, whereas the position of the display device 400 can be determined by the plurality of second sensors 130. The display device 400 is equipped with a correction system 300 which is not shown.

When information is input to such a large signage with a touch, the touch area significantly changes depending on the touch position. Additionally, the shift of the touch position is increased, and the shift is remarkable particularly at the edge portion of the display region 108. However, the correction is performed with the correction system 300, by which a touch operation without incongruity can be carried out even if the touch position is shifted or the touch area fluctuates.

Additionally, as described in the First Embodiment, the correction system 300 is able to monitor the configuration of the display devices 100 and 400 whenever necessary and generate a correction coefficient in accordance with the configuration. Hence, it is possible to always perform a touch operation without incongruity even when the display device 400 with an arbitral configuration is arranged at an arbitral place.

The aforementioned modes described as the embodiments of the present invention can be implemented by appropriately combining with each other as long as no contradiction is caused. Furthermore, any mode which is realized by the persons ordinarily skilled in the art through the appropriate addition, deletion, or design change of elements or through the addition, deletion, or condition change of a process is included in the scope of the present invention as long as they possess the concept of the present invention.

In the specification, although the cases of the organic EL display device are exemplified, the embodiments can be applied to any kind of display devices of the flat panel type such as other self-emission type display devices, liquid crystal display devices, and electronic paper type display device having electrophoretic elements and the like. In addition, it is apparent that the size of the display device is not limited, and the embodiment can be applied to display devices having any size from medium to large.

In addition, the display device may be a display device having only one of the first sensor and the second sensor in each of the Embodiments described above. For example, when a display device is fixed and used as a stationary advertisement as shown in FIG. 13, it is not necessary to estimate an angle thereof. Therefore, an embodiment includes a structure having only the first sensor, a structure including a sensor and a system for determining a position of a user in addition to the first sensor, and a correction method of a touch operation when these structures are used. For example, as shown in FIG. 6A, when used in a wristwatch in which the curved surface of the display region is fixed, the embodiment may include a structure where the angle is determined by the second sensor and sensitivity of the touch panel is adjusted and a correction method of a touch operation by using the structure.

It is properly understood that another effect different from that provided by the modes of the aforementioned embodiments is achieved by the present invention if the effect is obvious from the description in the specification or readily conceived by the persons ordinarily skilled in the art.

What is claimed is:

1. A display device comprising:
a display panel;
a touch sensor overlapping with the display panel;
at least one first sensor which changes in shape according to a change in shape of the display panel; and
at least one second sensor which is an acceleration sensor.

2. The display device according to claim 1,
wherein a resistance of the first sensor increases with increasing curvature of the first sensor.

3. The display device according to claim 1,
wherein the first sensor overlaps with the display panel.

4. The display device according to claim 1,
wherein the at least one first sensor comprises a plurality of first sensors,
the display panel comprises a display region having a square shape with first to fourth sides,
the first sensors surround the display region, and
each of the first sensors is arranged along respective one of the first to four sides.

5. The display device according to claim 1,
wherein the second sensor overlaps with the display panel.

6. The display device according to claim 1,
wherein the display panel has flexibility.

7. The display device according to claim 1, further comprising a housing including the display panel, the touch sensor, the first sensor, and the second sensor.

8. The display device according to claim 1,
wherein the touch sensor is configured to determine a x coordinate and a y coordinate of a touch to the display device,
the display panel further comprises:
a first circuit configured to determine a configuration of the display device; and
a second circuit configured to correct the x coordinate and the y coordinate according to an output of the first circuit.

9. The display device according to claim 8,
wherein the configuration includes a shape and a position of the display device,
the position is an angle between a tangent and a horizon,
the tangent perpendicularly intersects a standard line and is in contact with a surface of the touch sensor when the standard line is a line which passes an arbitrarily selected point on the surface of the touch sensor and which is parallel to a side of the display panel.

10. The display device according to claim 9,
wherein the side is a linear side.

11. The display device according to claim 8,
wherein the configuration includes a shape and a position of the display device,
the position is an angle between a vector of a normal line of the display panel and a horizon, the normal line passing through an arbitrarily selected point on a surface of the touch sensor.

12. A correction method of a touch operation of a display device comprising; a display panel; a touch sensor overlapping with the display panel; at least one first sensor which changes in shape according to a change in shape of the display panel; and at least one second sensor as an acceleration sensor, the correction method comprising;
determining a configuration of the display device by using the first sensor and the second sensor;
determining a x coordinate and a y coordinate of a touch to the display panel by using the touch sensor; and
correcting the x coordinate and the y coordinate according to the configuration.

13. The correction method according to claim 12,
wherein the first sensor has flexibility, and
a resistance of the first sensor increases with increasing curvature of the first sensor.

14. The correction method according to claim 13,
wherein the configuration includes a shape of the display device,
the display device has a shape-information memory,
data of shapes of the display device and data of resistivities of the first sensor are stored in the shape-information memory, each of the shapes corresponding to each of the resistivities, and
the correction method includes reading one of the shapes from the shape-information memory, the one of the shapes corresponding to one of the resistivities closest to a resistivity demonstrated by the first sensor.

15. The correction method according to claim 12,
wherein the configuration includes a position of the display device,
the display device has a shape-information memory,
data of positions of the display device and data of signals output by the second sensor are stored in the shape-information memory, each of the positions corresponding to each of the signals, and
the correction method includes reading one of the positions from the shape-information memory, the one of the positions corresponding to one of the signals closest to a signal output by the second sensor.

16. The correction method according to claim 12,
wherein the display device has a correction-value memory,
data of configurations and data of correction coefficients are stored in the correction-value memory, each of the configurations corresponding to each of the correction coefficients, and
the correction method includes reading one of the correction coefficients from the correction-value memory, the one of the correction coefficients corresponding to one the configurations closest to a configuration determined by the first sensor and the second sensor.
